(19) United States
(12) Patent Application Publication
(10) Pub. No.: US 2004/0122630 A1
(43) Pub. Date: Jun. 24, 2004

(54) Method and apparatus for linking finite element models to computer-aided design models

(76) Inventor: Wallace Ronald Hugh Fife, Omemee (CA)

Correspondence Address: John S. Beulick, Armstrong Teasdale LLP, Suite 2600, One Metropolitan Sq., St. Louis, MO, 63102, US

(21) Appl. No.: 10/324,777

(22) Filed: Dec. 19, 2002

(51) Int. Cl. G06F 17/10

(52) U.S. Cl. 703/2

(57) ABSTRACT

A method and apparatus for performing a Finite Element Analysis (FEA) for an object are described. In one example, the method includes creating a Computer Aided Design (CAD) model of the object wherein at least one of a part and an assembly is associated with a parameter indicative of at least one of a suppress for analysis feature and a maintain for analysis feature and generating a FEA model based on the CAD model.

### BACKGROUND OF THE INVENTION

This invention relates generally to Finite Element Analysis of objects and more specifically to methods and apparatus for linking Finite Element Analysis models to Computer-Aided Design production models.

Many parts and components used in the manufacture of products are designed and analyzed on computers before the parts are produced in a factory. In this process, Computer-Aided Design (CAD) programs generate a model of a part, a Finite Element Analysis (FEA) analyzes the structural and operational movement and stresses on the part, and Computer-Aided Manufacturing (CAM) programs guide the automated machines that create the physical part from the model.

Computer-Aided Design (CAD) is used to create a mathematical model that represents a mechanical part or assembly to be designed. The model is created in several steps, including, specifying attributes, such as for example, material and thickness, defining boundary conditions, applying loads, and defining contacts in the model to set relationships between geometries.

Once the model is defined, a mesh is generated. A mesh subdivides the design model into a plurality of smaller, simpler interconnected components called elements. In many cases, it is unnecessary to include all of the fine, finished details of the CAD part or assembly model when submitting the model for finite element analysis. More specifically, if an analysis included all of the details of a CAD part or assembly, the FEA may require an exorbitant calculation time and produce an undesirably large number of small mesh elements.

Many modern CAD programs have the ability to mesh the model and as such, it is advantageous to simplify the geometry of the design model by eliminating any features that are unnecessary to the completion of the analysis. Meshing includes simplifying the part's geometry, adding coordinate systems, and adding datum points to enable proper meshing of the model. Simplifying the part's geometry facilitates reducing the computing power and time required for the FEA by temporarily removing features of an object or assembly from the model that are not essential features. Non-essential features, such as rounds, chamfers, fillets and small holes, are suppressed in the model before meshing. The process of suppressing non-essential features, or “defeaturing,” is a time consuming task that is done each time a FEA is run on an object. Coordinate systems are used as references for specifying the vector components of loads and constraints. The references are specified using a coordinate system. More specifically, a Cartesian coordinate system is used with X, Y, and Z components, a cylindrical coordinate system is used with radius, theta, and Z components, and a spherical coordinate system is used with radius, theta, and phi components. Datum points are added to position loads, mesh constraints, bar elements, and mass elements. Datum points are also used to locate constraints when the part features or geometry do not implicitly define the constraints.

After the model is meshed, the CAD system outputs the model to a Finite Element Analysis (FEA) program. The FEA program creates a mathematical simulation of the part or assembly, and its boundary conditions and loads. It then analyzes the structural integrity of the part or assembly based on this simulation. The FEA program displays the results of the analysis in a variety of graphical and tabular formats.

### BRIEF SUMMARY OF THE INVENTION

In one aspect, a method for performing a Finite Element Analysis (FEA) for an object is provided. The object includes at least one of part and an assembly, wherein the assembly includes at least one of a part and an assembly. The method includes the steps of creating a Computer Aided Design (CAD) model of the object wherein at least one of the part and the assembly is associated with a parameter indicative of at least one of a suppress for analysis feature and a maintain for analysis feature and generating a FEA model based on the CAD model.

In another aspect, an apparatus for performing a FEA for an object is provided. The object includes at least one of a part and an assembly. The apparatus includes a CAD model of the object wherein at least one of the part and the assembly is associated with a parameter indicative of at least one of a suppress for analysis feature and a maintain for analysis feature and a computer configured to generate a FEA model based on the CAD model.

### BRIEF DESCRIPTION OF THE DRAWINGS

FIG. 1 is a simplified block diagram of an Object Model Structure for an object to be modeled wherein all parts of the object have similar material properties.

FIG. 2 is a simplified block diagram of an Object Model Structure for an object to be modeled wherein some of the parts have different material properties.

FIG. 3 is a block diagram of a file structure of an exemplary embodiment of a CAD system model file.

FIG. 4 is a flowchart illustrating example processes utilized by a CAD system.

### DETAILED DESCRIPTION OF THE INVENTION

Example embodiments of systems and processes that perform Finite Element Analyses for design parts and assemblies related to a Computer-Aided Design System are described below in detail. The systems and processes facilitate, for example, linking an object design model in a CAD system to a finite element model in a Finite Element Analysis system. The CAD system permits entry of parameters relating to a part's structure, surface, material, position and relation to other parts making an assembly. The CAD system also allows programming of conditional statements to manipulate the model based on features assigned to the model parts and assemblies.

In the exemplary embodiment, the CAD system is utilized to prepare an object model by preparing part models, assigning a relationship between several parts that make up an assembly, and assigning a parameter to each part and assembly indicating its importance in a Finite Element Analysis. Part model data includes at least one of a material property, boundary limit, contact between surfaces, loads and constraints, regions in the model that divide the model surface, and any other information relating to the treatment of a model within a specific analysis.

Handling of the model is determined by programming in the CAD system that contains conditional statements for manipulating the model to accommodate various analysis requirements. For example, removing of non-essential features of a part to facilitate a Finite Element Analysis is programmed into the part model data. When a request is made to export the model to a FEA program, the conditional programming statements in conjunction with the part parameters defining the model, cause the model non-essential features to be removed prior to the model being exported to the FEA program.

In one embodiment, a computer system is provided, and the programming is embodied on a computer readable medium. In another embodiment, the system is web enabled and is run on a business-entity intranet. In yet another embodiment, the system is fully accessed by individuals having an authorized access outside the firewall of the business-entity through the Internet. In a further example embodiment, the system is being run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

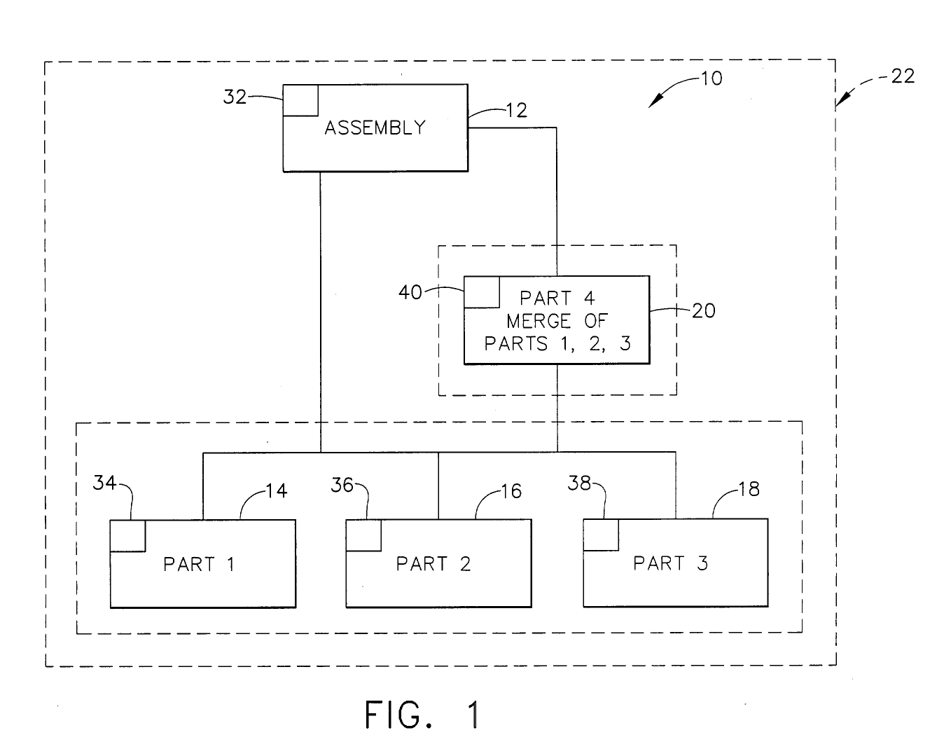

FIG. 1 is a simplified block diagram of an Object Model Structure for an object 10 including an assembly 12, a part 14, a part 16, a part 18, and a blank part 20. In another embodiment, object 10 includes a different number of assemblies and parts. Assembly 12, part 14, part 16, part 18, and blank part 20 exist as files in a CAD system 22 or similar computer-based system for designing assemblies, parts and components for manufacture or analysis. Part and assembly files are discussed below. Each part and assembly file includes a parameter indicating whether or not the part or assembly will be suppressed during an analysis of object 10. Assembly 12 includes parameter 32, parts 14, 16, 18, and 20 include parameters 34, 36, 38, and 40 respectively. Assembly 12 is an upper tier structure including sub-assemblies or parts. FIG. 1 shows one level of complexity for the structure. Parts 14, 16 and 18, in many cases are assemblies at the next lower level of complexity and assembly 12 can be a part in an assembly at the next higher level of complexity. An object 10 can have any number of levels of complexity. In an alternative embodiment, the Object Model Structure for a more complex object has, for example, three levels of complexity wherein the uppermost assembly includes parts that are also assemblies in the next lower level of complexity.

Part 20 is a blank part. A blank part is a merge of several parts at the same level of complexity that is used to simplify analysis performed on the object. Blank part 20 is created in the CAD system 22 and parts 14, 16 and 18 are added to part 20 as features. This step, in effect, makes part 20 an assembly of parts 14, 16 and 18 but, at the same level of complexity. Merging parts 14, 16 and 18 into part 20 is possible only if parts 14, 16 and 18 are sufficiently similar to each other to allow them to be merged. If, for example, parts 14, 16 and 18 are not all the same material, they will not be able to be merged into one part 20. The part model data associated with each of parts 14, 16 and 18 includes material property data. Part 20 also has material property data associated with it but, because of analysis restraints, a part being analyzed must be of one material. To yield proper analysis results, parameters 34, 36, 38 and 40 are added to the file describing each of parts 14, 16, 18 and 20, respectively. Parameters 34, 36, 38 and 40 control the representation of parts 14, 16, 18 and 20 when assembly 12 is exported for analysis. Conditional programming statements within CAD system 22 will allow the export of parts 14, 16 and 18, and suppress part 20 so that it is not analyzed. Alternatively, conditional programming statements will allow the export of part 20, and suppress parts 14, 16 and 18 so that they are not analyzed. An exemplary conditional statement is:

INPUT

INCLUDE_HOLE YES_NO

“Should the hole be included?:”

IF INCLUDE_HOLE==YES

HOLE_DIA NUMBER

“Enter diameter for hole”

ELSE

. . .

ENDIF

. . .

END INPUT

In another embodiment, the conditional statement contains code in a format that is recognizable to a particular CAD program being used.

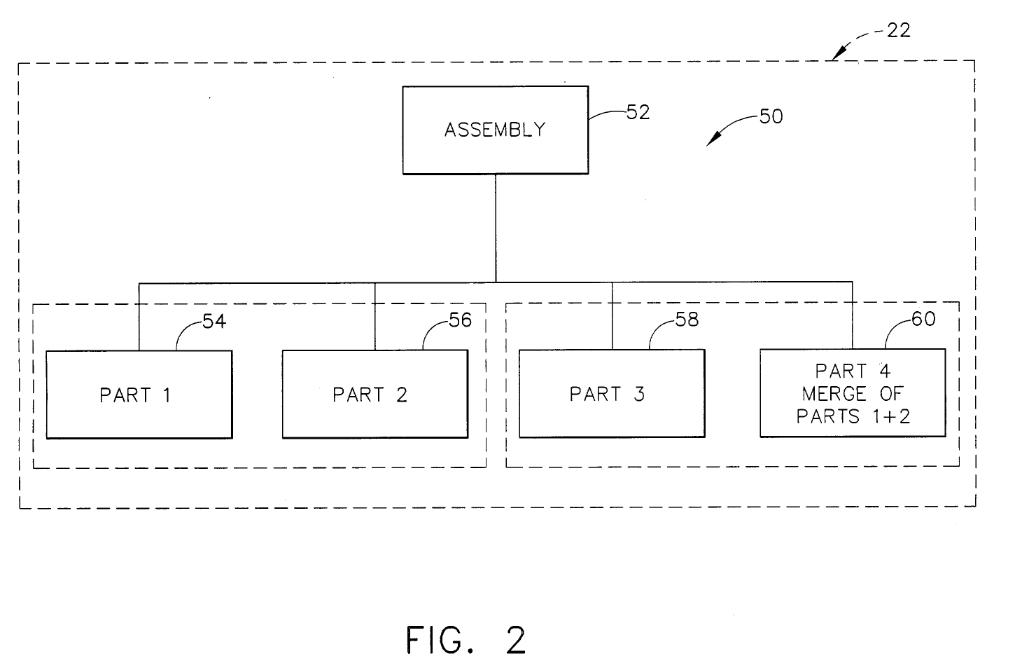

FIG. 2 is a simplified block diagram of an Object Model Structure for an object 50 including an assembly 52, a part 54, a part 56, a part 58, and a blank part 60. In this embodiment, part 58 is represented as being manufactured of a different material than parts 54 and 56. As explained above, only parts of similar material properties can be merged into blank part 60. Parts 54 and 56 are merged into blank part 60 by including parts 54 and 56 in part 60 as features. Part 58 will be exported to the analysis program as a separate part from part 60 due to its material properties being different from parts 54 and 56. In another embodiment, other model data dissimilarity prevent merging parts 54 and 56 into part 60 such as, for example, part 54 and 56 not having a common surface or contact point. In the exemplary embodiment, two parts, 54 and 56, are merged into one blank part 60. In an alternative embodiment, an assembly may include any number of blank parts, including zero, with any number of merged parts added as features.

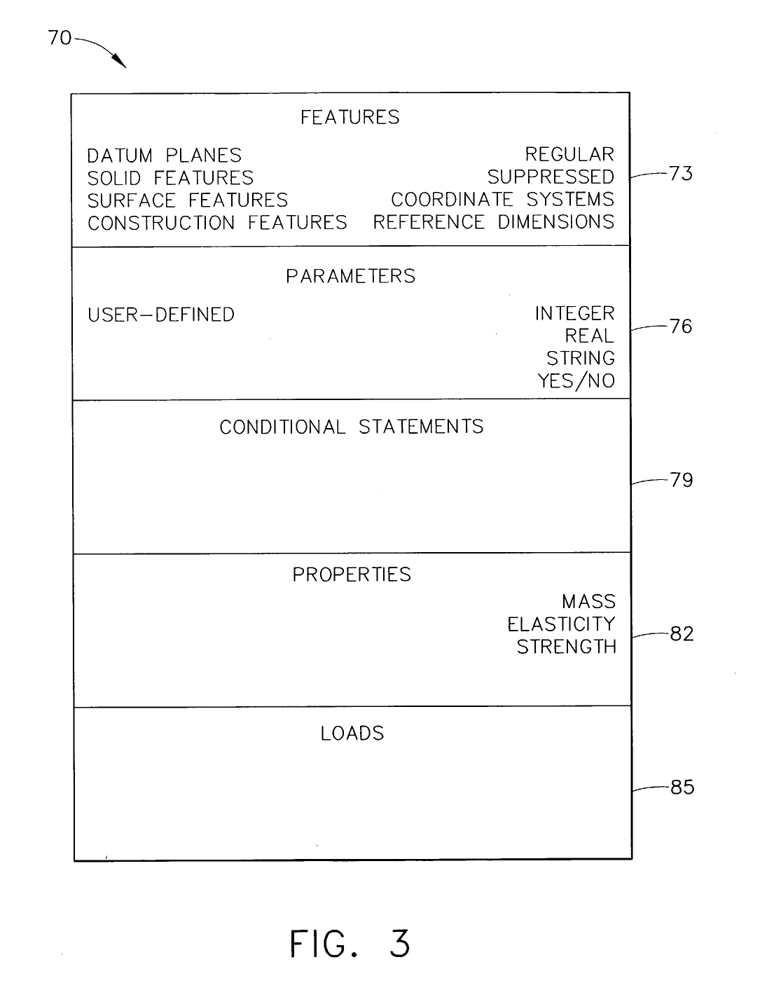

FIG. 3 is a block diagram of the file structure of an exemplary embodiment of a CAD system model file 70. File 70 is organized to store data representing a part or assembly. A feature 73 area stores physical data relating to a part's geometry. The various types of features 73 are used as building blocks in the progressive creation of solid parts. Features 73 have the ability to be suppressed such that the dimensions described by the features are temporarily removed from the model.

Parameters 76 are user-defined variables that hold data particular to a user's requirements including for example cost data for material or fabrication, and operands for a conditional statement 79 programmed into the model. Conditional statements 79 in file 70 permit users to modify the modeling process without constant intervention by automating steps in the modeling process based on parameters 76 contained in file 70. In the exemplary embodiment, conditional statements 79 operate on parameter analysis_param located in parameters 76 to suppress features of the CAD model prior to linking the CAD system 22 model to a FEA program based on the state of parameter analysis_param. Conditional statements 79 also contain instructions for passing analysis_param states from each assembly 12 to parts 14, 16, and 18 contained within assembly 12.

Physical properties of parts or assemblies represented by file 70 are contained in a properties 82 area of file 70. Information included in properties 82 is density of the material, elasticity, and strength. Depending on the object being modeled, additional properties are specified. Loads 85 imposed on the object during the FEA are contained in loads 85 area of file 70. Boundary conditions 85 include loads acting on the object and constraints that define how the object is restrained. Examples of loads are: gravity, pressure, forces, moments, and thermal loads. Examples of constraints are: restriction of translation and/or rotation with respect to one or more coordinate system axes, such as, for example, a Cartesian system, a cylindrical system, and a spherical system.

The information contained in file 70 enables the FEA to produce results in the computer object that accurately reflect the responses of the physical object subject to stresses in the physical world.

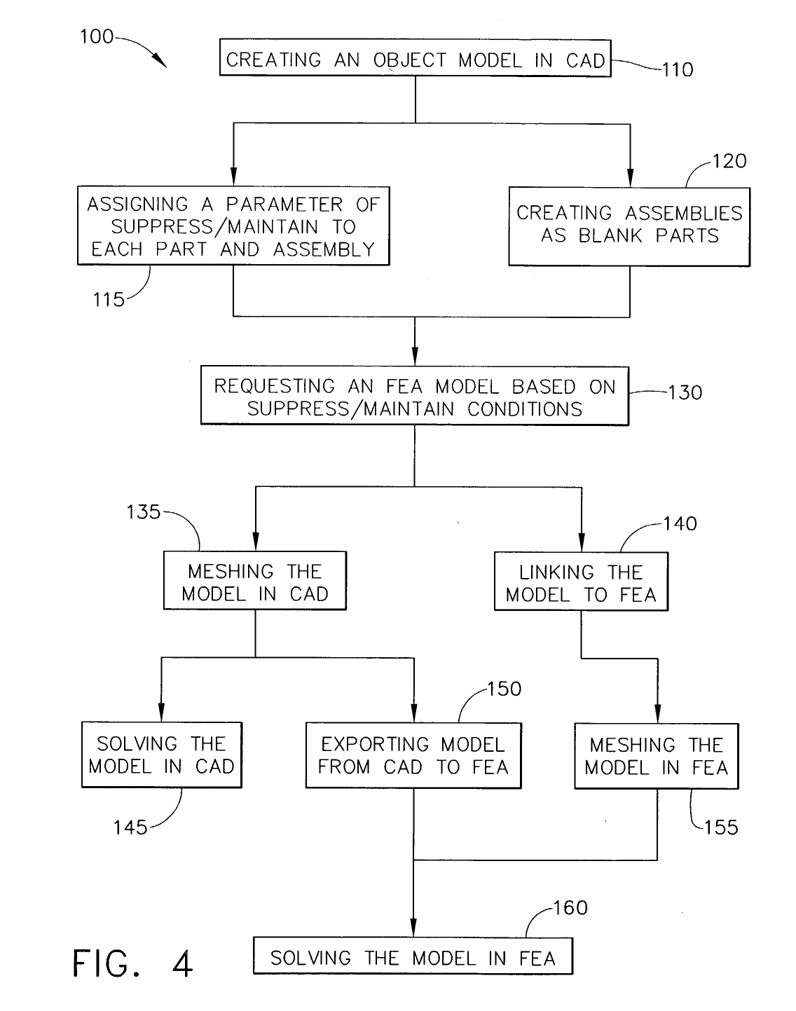

FIG. 4 is a flowchart illustrating example processes utilized by a CAD system 100. The step of creating 110 an object model in CAD is dependent on the CAD system used by a user. Each CAD system has its own procedures for creating the model. In one embodiment, an object is created by defining features of a part, combining parts into assemblies by defining relationships between the parts and combining assemblies, if necessary, to create the model of the object. Assemblies are constructed of any level of complexity by combining parts and assemblies into more complex assemblies until all details of the object modeled. The model is embodied in a computer readable file on a computer readable media. Assigning 115 a parameter of Suppress/Maintain to each part and assembly is performed by editing the computer readable file in the CAD system. The computer file includes parameters, statements, and features of the modeled object. Some known CAD systems permit a user to define parameters relating to a modeled object. In one embodiment, a parameter, “analysis_param” is used to indicate whether a part or assembly will be included in a requested FEA. Once an object model is created, a file associated with the model is edited to assign a value for analysis_param. A value of, for example “suppress” indicates the non-essential features of the part are not needed for the FEA and are suppressed before the model is linked to the FEA program. Conditional statements in the CAD file representation of the object modify the object model based on the state of parameters set in the file by a user.

The value of analysis_param in a top-level assembly is passed down to lower level parts and assemblies. In this manner, an assembly for which a FEA is requested will have all non-essential features suppressed during the FEA.

Alternatively, another embodiment of the method of preparing the CAD model for linking to the FEA program is creating 120 assemblies as a blank part. To accomplish this a blank part 20 is added to an assembly 12. Parts 14, 16, and 18 are added to a file for blank part 20 as features. All of parts 14, 16, and 18 to be combined into part 20 need to have the same material properties (shown in FIG. 1). Therefore, assembly 12 is made to look like a part 20 to CAD system 22. Merging parts 14, 16 and 18 into one part 20 facilitates compressing solids. Conditional statements added to the CAD file for part 20 will suppress part 20 when the value of analysis_param is set to suppress, as in the case when a FEA is not requested. Conditional statements added to parts 14, 16, and 18 will conversely not suppress parts 14, 16, and 18 when a/FEA is not requested. This method ensures either parts 14, 16 and 18 or part 20 will be analyzed.

An alternative method of preparing the CAD model for linking to the FEA program is used when one or more parts of an assembly 52 have different material properties from other parts in the same assembly. Refer also to FIG. 2. In the example shown in FIG. 2, creating 120 assemblies as blank parts when a part 54 and a part 56 are designed with different material properties than a part 58, only parts 54 and 56 can be merged into a blank part 60. In this example, only part 54 and 56 are merged into part 60. Part 58 remains a separate part in assembly 52 for the FEA.

After combining parts 58 and 60 into assembly 52, a user requests 130 an FEA model based on the suppress/maintain conditional statements entered into CAD model files associated with each part and assembly. CAD system 22 manipulates data in each file to suppress features predetermined by the suppress/maintain conditional statements.

In one embodiment, CAD system 22 includes a mesher and meshing 135 of the defeatured model is performed by CAD system 22. After meshing, the model is solved 145 in CAD system 22 or the model is exported 150 to a FEA program for solving. In an alternative embodiment, the defeatured model is linked 140 to an FEA program that includes a mesher and meshing 155 is performed by the FEA program. Alternatively, a stand alone mesher program is used to mesh the model before linking 140 the model to the FEA program. Following meshing, the model is solved. In one embodiment, solving 145 of the meshed model is performed in CAD system 22. In another embodiment, solving 160 of the meshed model is performed in the FEA program.

The above-described method of linking a CAD model to a FEA model is cost-effective and highly reliable. The method includes creating a Computer Aided Design (CAD) model of the object wherein at least one of the part and the assembly is associated with a parameter of at least one of a suppress for analysis feature and a maintain for analysis feature and generating a Finite Element Analysis (FEA) model based on the CAD model. Accordingly, the above-described method facilitates reducing modeling time and effort in a cost-effective and reliable manner.

Exemplary embodiments of a system and method for linking CAD production models to FEA models are described above in detail. The systems are not limited to the specific embodiments described herein, but rather, components of the system may be utilized independently and separately from other components described herein. Each system component described herein can also be used in combination with other system components.

While the invention has been described in terms of various specific embodiments, those skilled in the art will recognize that the invention can be practiced with modification within the spirit and scope of the claims.

What is claimed is:

1. A method for performing a Finite Element Analysis (FEA) for an object including at least one of a part and an assembly, wherein the assembly includes at least one of a part and an assembly, said method comprising:
creating a Computer Aided Design (CAD) model of the object wherein at least one of the part and the assembly is associated with a parameter indicative of at least one of a suppress for analysis feature and a maintain for analysis feature; and
generating a Finite Element Analysis (FEA) model based on the CAD model.

2. A method in accordance with claim 1 wherein creating a Computer Aided Design model further comprises:
creating a CAD model of the object wherein each part and assembly is associated with a parameter of at least one of a suppress for analysis feature and a maintain for analysis feature; and
associating each part of the assembly with the parameter of the assembly.

3. A method in accordance with claim 1 wherein generating a FEA model further comprises:
generating a FEA model based on the CAD model utilizing the parameters associated with the parts and the assemblies.

4. A method in accordance with claim 3 wherein generating a FEA model further comprises generating a FEA model based on the CAD model utilizing the parameters associated with the parts and the assemblies by suppressing at least one of the part and the assembly with an associated parameter of suppress for analysis feature.

5. A method in accordance with claim 3 wherein generating a FEA model further comprises the step of generating a FEA model based on the CAD model utilizing the parameters associated with the parts and the assemblies by
suppressing all parts and assemblies with associated parameters of suppress for analysis feature.

6. A method in accordance with claim 5 wherein generating a FEA model further comprises generating a FEA model based on the CAD model utilizing the parameters associated with the parts and the assemblies by
suppressing only each part and assembly with associated parameters of suppress for analysis feature such that all parts and assemblies with associated parameters of maintain for analysis feature are not suppressed.

7. A method in accordance with claim 1 wherein creating a CAD model of the object further comprises:
creating a CAD model of the object including at least one blank part including at least one feature.

8. A method in accordance with claim 7 wherein creating a CAD model of the object including at least one blank part including at least one feature further comprises:
including all parts of an assembly as features of the blank part.

9. A method in accordance with claim 7 wherein creating a CAD model of the object including at least one blank part including at least one feature further comprises:
associating a parameter of at least one of a suppress for analysis feature and a maintain for analysis feature to the blank part.

10. A method in accordance with claim 1 wherein creating a CAD model of the object further comprises meshing the model.

11. A method in accordance with claim 1 wherein creating a CAD model of the object further comprises solving the model.

12. A method in accordance with claim 1 wherein creating a CAD model of the object further comprises exporting the model.

13. A method in accordance with claim 1 wherein generating a FEA model based on the CAD model further comprises:
importing the model;
meshing the model; and
solving the model.

14. An apparatus for performing a FEA for an object, the object including at least one of a part and an assembly, said apparatus comprising:
a CAD model of the object wherein at least one of the part and the assembly is associated with a parameter indicative of at least one of a suppress for analysis feature and a maintain for analysis feature; and
a computer configured to generate a Finite Element Methods (FEA) model based on the CAD model.

15. An apparatus in accordance with claim 14 wherein each part and assembly of the object is associated with a parameter indicative of at least one of a suppress for analysis feature and a maintain for analysis feature.

16. An apparatus in accordance with claim 14 wherein said computer is further configured to generate a FEA model based on the CAD model utilizing the parameters associated with the parts and the assemblies.

17. An apparatus in accordance with claim 16 wherein said computer is further configured to suppress for analysis at least one of a part with an associated indication of suppress for analysis feature and an assembly with an associated indication of suppress for analysis feature.

18. An apparatus in accordance with claim 16 wherein said computer is further configured to suppress all parts and assemblies with associated parameters of suppress for analysis feature.

19. An apparatus in accordance with claim 18 wherein said computer is further configured to suppress only each part and assembly with associated parameters of suppress for analysis feature such that all parts and assemblies with associated parameters of maintain for analysis feature are not suppressed.

20. An apparatus in accordance with claim 14 wherein said computer is further configured to create a CAD model including at least one blank part including at least one feature.

21. An apparatus in accordance with claim 20 wherein said computer is further configured to include all parts of an assembly as features of the blank part.

22. An apparatus in accordance with claim 20 wherein said computer is further configured to associate a parameter of at least one of a suppress for analysis feature and a maintain for analysis feature to the blank part.

23. An apparatus in accordance with claim 14 wherein said computer is further configured to mesh the model.

24. An apparatus in accordance with claim 14 wherein said computer is further configured to solve the model.

25. An apparatus in accordance with claim 14 wherein said computer is further configured to export the model.

26. An apparatus in accordance with claim 14 wherein said computer is further configured to import the model, mesh the model, and solve the model.
